(19) United States
(12) Patent Application Publication
(10) Pub. No.: US 2014/0025969 A1
(43) Pub. Date: Jan. 23, 2014

(54) CONTROL CIRCUIT FOR COMPUTER

(71) Applicants: HON HAI PRECISION INDUSTRY CO., LTD., New Taipei (TW); HONG FU JIN PRECISION INDUSTRY (ShenZhen) CO., LTD, ShenZhen (CN)

(72) Inventors: AI-YU PAN, Shenzhen (CN); JIAN-SHE SHEN, Shenzhen (CN)

(73) Assignees: HON HAI PRECISION INDUSTRY CO., LTD., New Taipei (TW); HONG FU JIN PRECISION INDUSTRY (ShenZhen) CO., LTD, ShenZhen (CN)

(21) Appl. No.: 13/948,202

(22) Filed: Jul. 23, 2013

(30) Foreign Application Priority Data
Jul. 23, 2012 (CN) 2012102545757

(51) Int. Cl. G06F 1/32

(52) U.S. Cl. CPC G06F 1/3234
USPC 713/320

(57) ABSTRACT

A control circuit for a motherboard with a power supply unit arranged thereon includes a processing unit. To save consumption of electrical energy, the processing unit controls a switch unit to discontinue regulating a first power to a second power in a condition where a state of the motherboard is changed from state S0 to state S5.

### BACKGROUND

1. Technical Field

The present disclosure relates to a control circuit for a computer.

2. Description of Related Art

A power supply of the computer outputs various voltages when connected to the commercial power source, even if the computer shuts down. Accordingly, the computer will still consume a lot of power when connected to the commercial power source, which is not energy-efficient.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a control circuit for a computer of the present disclosure, wherein the control circuit includes a processing unit, a switch unit, a delay unit, and a control unit.

FIG. 2 is a circuit diagram of the processing unit of FIG. 1.

FIG. 3 is a circuit diagram of the switch unit of FIG. 1.

FIG. 4 is a circuit diagram of the delay and control units of FIG. 1.

### DETAILED DESCRIPTION

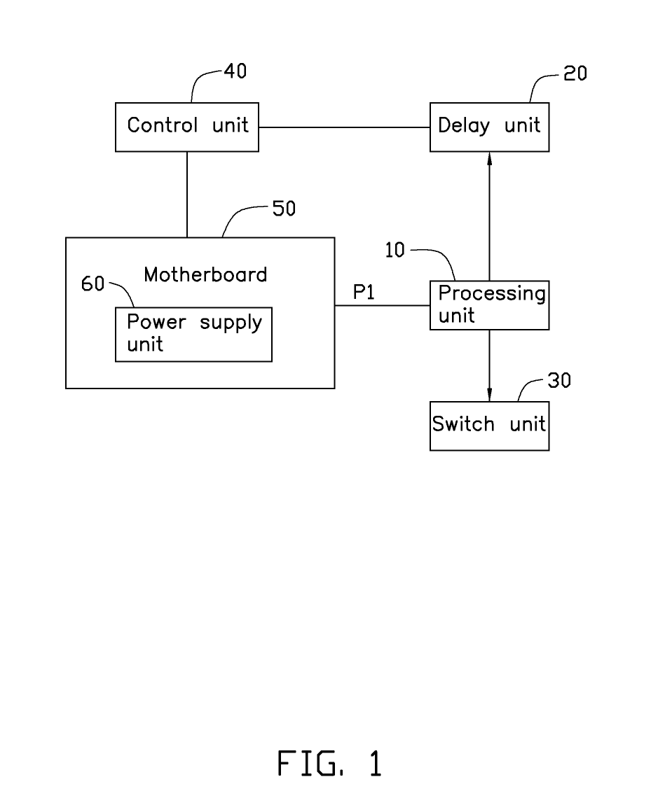

FIG. 1 illustrates an embodiment of a control circuit for a computer of the present disclosure. The control circuit includes a processing unit 10, a switch unit 30, a delay unit 20, and a control unit 40.

The processing unit 10 outputs an enable signal and a status signal according to a power signal (such as a PS_ON signal outputted by a motherboard 50) to the switch unit 30 and to the delay unit 20 respectively. The switch unit 30 regulates or does not regulate a first power to a second power, according to the enable signal. The delay unit 20 outputs a corresponding signal to the control unit 40 according to the status signal, so as to prompt the control unit 40 to power on or power off the motherboard 50. In the embodiment, the second power is a standby power, such as a power source P5V_STBY, by which the computer can be wakened from a standby state.

According to the working principle of the computer, when the computer is in a standby state, such as in ACPI (Advanced Configuration and Power Interface) S5 state, in which the computer shuts down with a power supply unit 60 still outputting the standby power, the power signal outputted from the motherboard 50 of the computer is at a high level, such as logic 1. When a power button of the computer is pushed, the power signal is changed to a low level, such as logic 0. When the power supply unit 60 of the computer receives the low level power signal (defined as a first switch signal), the power supply unit 60 will output all voltages, such as P1V5_AUX, P1V0_AUX, P0V75_AUX, and 12 volts (V). The motherboard will turn on, and an ACPI_S0 state entered, in which the computer operates. When the computer shuts down by pressing the power button again, the power signal is changed from a low level to a high level, the computer will shut down when receiving the high level power signal (defined as a second switch signal) from the motherboard 50. The computer is thus changed from the S0 state to the S5 state.

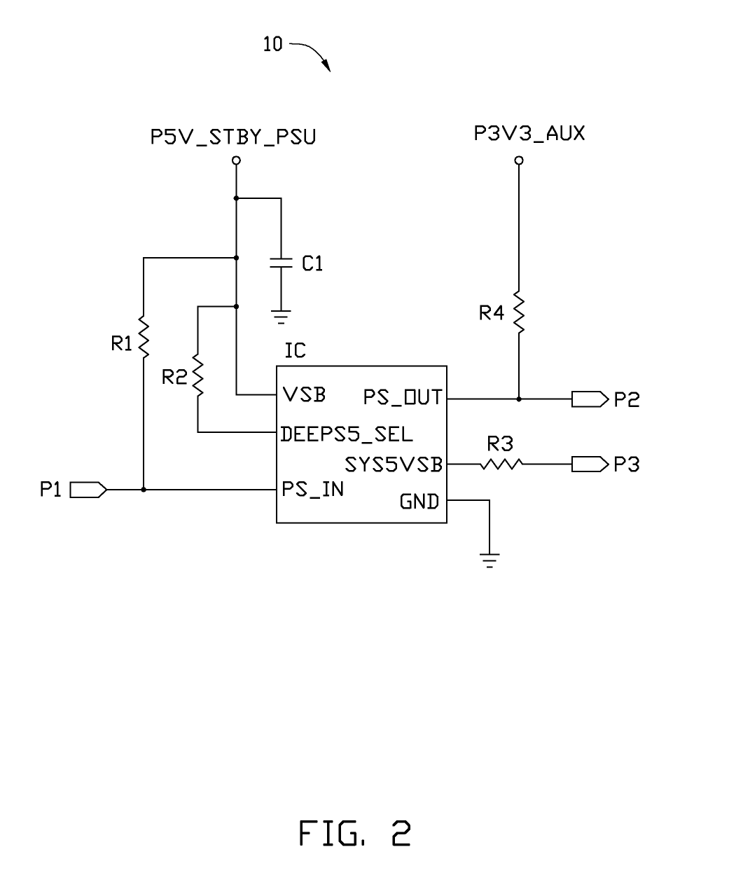

FIG. 2 shows that the processing unit 10 includes a control chip IC, four resistors R1-R4, and a capacitor C1. A configuration pin DEEPS5_SEL of the control chip IC is coupled to a power terminal P5V_STBY_PSU, which outputs the first power, through the resistor R2. When configuration pin DEEPS5_SEL of the control chip IC receives a high level from the power terminal P5V_STBY_PSU, the control chip IC is configured to control the motherboard 50 to enter a +S5 state, in which the power supply 80 outputs no standby power, such as the power source P5V_STBY being turned off.

A status output pin PS_OUT of the control chip IC is coupled to a power terminal

P3V3_AUX through the resistor R4. The control chip IC outputs a status signal to the delay unit 20 through the status output pin PS_OUT when an input pin PS_IN of the control chip IC receives the first or second switch signal. For example, when the input pin PS_IN of the control chip IC receives the first switch signal, the control chip IC outputs a low level status signal with a first determined time duration, such as 160 milliseconds (ms), after delaying for a second predetermined time, such as 160 ms, to the delay unit 20 through the output pin PS_OUT of the control chip IC. When the input pin PS IN of the control chip IC receives the second switch signal, the control chip IC outputs a high level status signal.

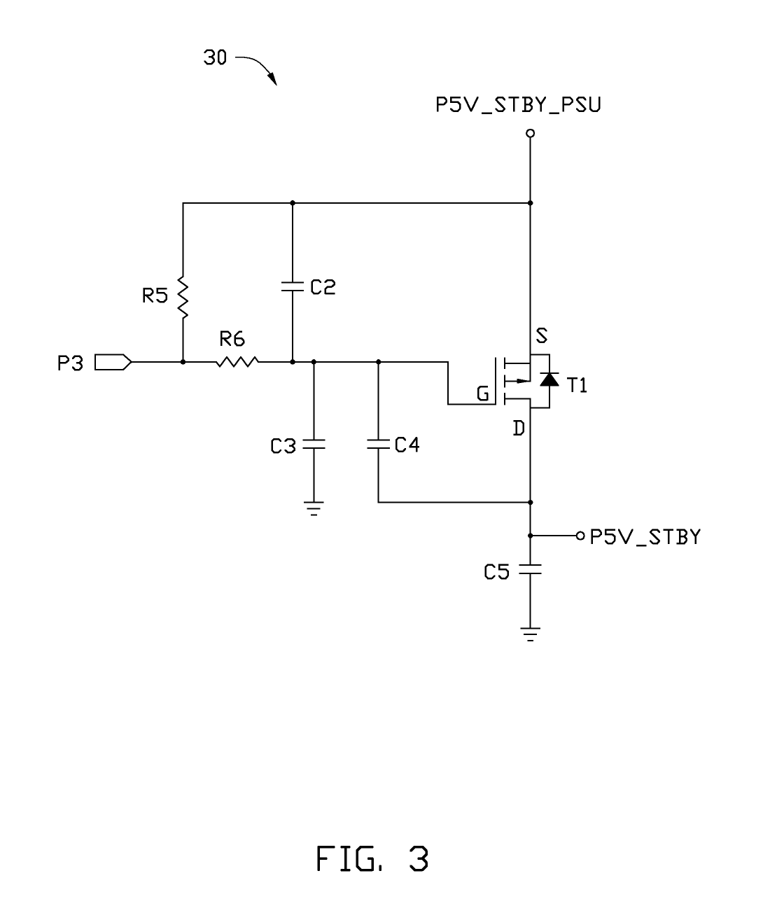

FIG. 3 shows that the switch unit 30 includes an electronic switch T1, two resistors R5 and R6, and four capacitors C2-C5. A first terminal of the electronic switch Ti is coupled to an enable pin SYS5VSB of the control chip IC through the resistor R6, to receive the enable signal. The first terminal of the electronic switch T1 is connected to ground through the capacitor C3. A second terminal of the electronic switch T1 is coupled to the power terminal P5V_STBY_PSU. A third terminal of the electronic switch T1 is connected to ground through the capacitor C5, and is also coupled to the first terminal of the electronic switch T1 through the capacitor C4. The third terminal of the electronic switch T1 is configured to provide a power terminal P5V_STBY, which outputs the second power. The first terminal of the electronic switch T1 is also coupled to the power terminal P5V_STBY_PSU through the resistors R6 and R5, in that order. When the first terminal of the electronic switch T1 is at a high level, the second terminal of the electronic switch T1 is disconnected from the third terminal of the electronic switch T1, and the power terminal P5V_STBY provides no power. When the first terminal of the electronic switch T1 is at a low level, the second terminal of the electronic switch T1 is connected to the third terminal of the electronic switch T1, and the first power from the power terminal P5V_STBY_PSU is regulated to the second power according to the enable signal. In the embodiment, the electronic switch T1 is a p-channel metal oxide semiconductor field effect transistor (pMOSFET), where a gate, a drain, and a source of the pMOSFET are respectively the first, the second, and the third terminals of the electronic switch T1.

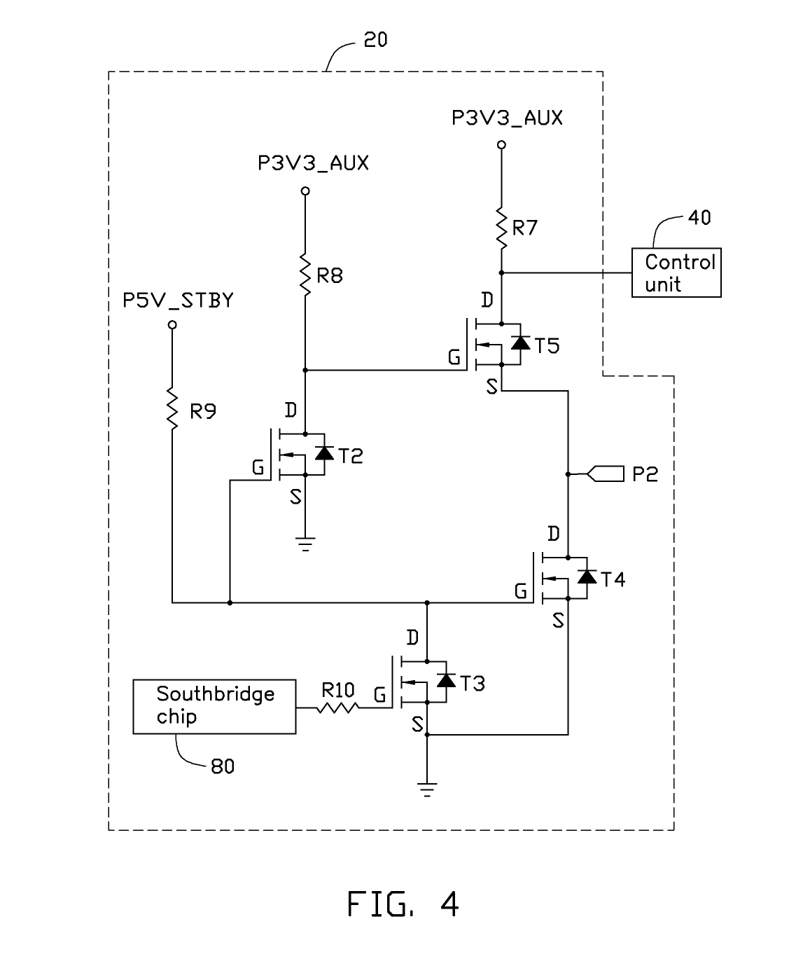

FIG. 4 shows that the delay unit 20 includes four electronic switches T2-T5 and four resistors R7-R10. A first terminal of the electronic switch T2 is coupled to the power terminal P5V_STBY through the resistor R9, to receive the second power. A second terminal of the electronic switch T2 is connected to a first terminal of the electronic switch T5. The second terminal of the electronic switch T2 is coupled to a power terminal P3V3_AUX through the resistor R8. A third terminal of the electronic switch T2 is connected to ground. A second terminal of the electronic switch T5 is coupled to the power terminal P3V3_AUX through the resistor R7. A third terminal of the electronic switch T5 is coupled to the status output pin PS_OUT of the control chip IC, to receive the status signal from the control chip IC. The second terminal of the electronic switch T5 is also connected to the control unit 40, and is configured to output the control signal to the control unit 40. A first terminal of the electronic switch T3 is configured to receive a reset signal from a southbridge chip 80 of the motherboard 50, where the reset signal is a high level signal outputted by the motherboard 50 within 0.5 seconds after the power terminal P3V3_AUX is activated by the power supply unit 60. The southbridge chip 80 controls the motherboard 50 to reboot when the high level reset signal is received. A second terminal of the electronic switch T3 is coupled to the power terminal P5V_STBY through the resistor R9, and is coupled to a first terminal of the electronic switch T4. A third terminal of the electronic switch T3 is connected to ground. A second terminal of the electronic switch T4 is coupled to the status output pin PS_OUT of the control chip IC, to receive the status signal from the control chip IC. A third terminal of the electronic switch T4 is connected to ground. When the first terminals of the electronic switches T2-T5 are at high level, the second terminals of the electronic switches T2-T5 are respectively connected to the third terminals of the electronic switches T2-T5. When the first terminal of the electronic switches T2-T5 are at low level, the second terminals of the electronic switches T2-T5 are respectively disconnected from the third terminals of the electronic switches T2-T5. In the embodiment, the electronic switches T2-T5 are n-channel metal oxide semiconductor field effect transistors (NMOSFETs), where gates, drains, and sources of the NMOSFETs are respectively the first, second, and third terminals of the electronic switches T2-T5.

The control unit 40 receives the control signals from the second terminal of the electronic switch T5, to power the motherboard 50 on or off. For example, when the control unit 40 receives a low level control signal with duration of the first predetermined time, the control unit 40 controls the motherboard 50 to reboot.

When the state of the motherboard 50 is changed from the state S5 to S0, which indicates that the computer is ready to be turned on, the motherboard 50 outputs the first switch signal. The control chip IC of the input pin PS_IN receives the first switch signal, and outputs a low level enable signal to the switch unit 30 through the enable pin SYS5VSB of the control chip IC. The first terminal of the electronic switch T1 receives the low level enable signal, and the second terminal of the electronic switch T1 is thus connected to the third terminal of the electronic switch T1, so as that the first power is regulated to the second power. Thus, the power terminal P3V3_AUX is able to provide power regulated from the power terminal P5V_STBY. In the meantime, the control chip IC of the processing unit 10 receives the first switch signal, and outputs a low level status signal with duration of the first predetermined time to the delay unit 20 through the status output pin PS_OUT. Meanwhile, the southbridge chip 80 will not receive a high level reset signal sooner than the end of a third predetermined time (such as 0.5 seconds), when the power terminal P3V3_AUX is generated. Accordingly, the electronic switch T3 is turned off, the electronic switches T2 and T4 are turned on and the electronic switch T5 is turned off. Hence, the second terminal of the electronic switch T5 is at high level, and the control unit 40 controls the motherboard 50 not to power on because of the high level signal. The southbridge chip 80 receives a high level reset signal after the third predetermined time, such as 0.5 seconds, so that the first terminal of the electronic switch T3 receives a high level. The second terminal of the electronic switch T3 is connected to the third terminal of the electronic switch T3. Accordingly, the electronic switches T2 and T4 are turned off, and the electronic switch T5 is turned on. The electronic switch T5 outputs the low level status signal with duration of the first predetermined time to the control unit 40. The control unit 40 controls the motherboard 50 to power on when the control signal is changed from a high level to a low level with duration of the first predetermined time. Accordingly, the delay unit 20 delays the low level status signal for the third predetermined time duration after the reset signal is changed to a high level.

When the state of the computer 50 is changed from the state S0 to S5, which indicates that the computer is turned off, the motherboard 50 outputs the second switch signal, and the control chip IC outputs a high level enable signal to the switch unit 30 through the enable pin SYS5VSB of the control chip IC. The electronic switch Ti is turned off when the first terminal of the electronic switch Ti receives the high level enable signal. Accordingly, the first power provided by the power terminal P5V_STBY_PSU cannot be regulated to the second power. Thus, the power terminal P5V_STBY outputs no voltage; neither does the power terminal P3V3_AUX. In the meantime, the control chip IC outputs the high level status signal through the status output pin PS_OUT to the third terminal of the electronic switch T5. Accordingly, the electronic switches T2-T5 are turned off. The second terminal of the electronic switch T5 is at a low level. The control unit 40 receives the low level signal, and controls the motherboard 50 to power off, such that the power terminals P5V_STBY and P3V3_AUX are turned off, to further reduce the power-consumption of the motherboard 50.

While the disclosure has been described by way of example and in terms of a preferred embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A control circuit for a motherboard with a power supply unit, comprising:
a processing unit outputting an enable signal and a status signal according to a power signal from the motherboard, wherein when the processing unit receives a low level power signal, the processing unit outputs a low level enable signal and a low level status signal with a first predetermined time duration, after a second predetermined time;
a switch unit regulating a first power outputted by the power supply unit to a second power upon a condition that receiving the low level enable signal;
a delay unit delaying the low level status signal from the processing unit upon a condition that receiving a low voltage reset signal from a southbridge chip, wherein when the reset signal is changed to a high level, the delay unit outputs a low level control signal with duration of the first predetermined time when receiving the high level reset signal; and
a control unit prompting the motherboard to power on when receiving the low level control signal with a duration of the first predetermined time.

2. The control circuit of claim 1, wherein the delay unit delays the low level status signal from the processing unit for a third predetermined time after the second power is generated.

3. The control circuit of claim 2, wherein when the processing unit receives a high level power signal, the processing unit outputs a high level enable signal, the switch unit does not regulate the first power to the second power upon a condition that receiving the high level enable signal.

4. The control circuit of claim 3, wherein when the switch unit does not regulate the first power to the second power, the delay unit outputs a low level control signal to the control unit, the control unit prompts the motherboard to turn off

5. The control circuit of claim 4, wherein the processing unit comprises a control chip and a first resistor, wherein a power pin of the control chip is coupled to the first power, an input pin of the control chip receives the power signal, a configuration pin of the control chip is coupled to the first power through the first resistor, a status output pin of the control chip is coupled to a third power source regulated from the second power.

6. The control circuit of claim 5, wherein the switch unit comprises a first electronic switch, a first terminal of the first electronic switch is coupled to an enable pin of the control chip, a second terminal of the first electronic switch is coupled to the first power, a third terminal of the first electronic switch is coupled to the second power; when the first terminal of the first electronic switch is at a low level, the second terminal of the first electronic switch is connected to the third terminal of the first electronic switch, to regulate the first power to the second power, when the first terminal of the first electronic switch is at a high level, the second terminal of the first electronic switch is disconnected from the third terminal of the first electronic switch, to disable the first power to be regulated to the second power.

7. The control circuit of claim 6, wherein the delay unit comprises second to fifth electronic switches, a first terminal of the second electronic switch is configured to receive the reset signal, a second terminal of the second electronic switch is coupled to the first power, and coupled to a first terminal of the third electronic switch, a third terminal of the second electronic switch is connected to ground; a second terminal of the third electronic switch is coupled to the status output pin of the control chip, a third terminal of the third electronic switch is connected to ground; a first terminal of the fourth electronic switch is coupled to the second power, a second terminal of the fourth electronic switch is coupled to the third power source, and coupled to a first terminal of the fifth electronic switch, a third terminal of the fourth electronic switch is connected to ground; a second terminal of the fifth electronic switch is coupled to the third power source, and outputs the control signal to the control unit; a third terminal of the fifth electronic switch is coupled to the second terminal of the third electronic switch, and coupled to the status output pin of the control chip, wherein when the first terminals of the second to fifth electronic switches are at low level, the second terminals of the second to fifth electronic switches are disconnected from the corresponding third terminals of the second to fifth electronic switches; when the first terminals of the second to fifth electronic switches are at high level, the second terminals of the second to fifth electronic switches are connected to the corresponding third terminals of the second to fifth electronic switches.

8. The control circuit of claim 7, wherein the first electronic switch is an n-channel metal oxide semiconductor field effect transistor (NMOSFET), where a gate, a drain, and a source of the NMOSFET transistor are respectively the first, the second, and the third terminals of the first electronic switch.

9. The control circuit of claim 8, wherein the second to fifth electronic switches are NMOSFETs, where gates, drains, and sources of the NMOSFET transistors are respectively the first, the second, and the third terminals of the second to fifth electronic switch.

10. The control circuit of claim 9, wherein the processing unit further comprises second to fourth resistors and a first capacitor, the power pin of the control chip is connected to ground through the first capacitor, the enable pin of the control chip outputs the enable signal through the second resistor, the status output pin of the control chip is coupled to the third power source through the third resistor, the input pin of the control chip is coupled to the second power through the fourth resistor.

11. The control circuit of claim 10, wherein the delay unit further comprises fifth to eighth resistors, the first terminal of the second electronic switch receives the reset signal from the south bridge chip through the fifth resistor, the second terminal of the second electronic switch is coupled to the first power through the sixth resistor, the second terminal of the fourth electronic switch is coupled to the third power source through the seventh resistor, the second terminal of the fifth electronic switch is coupled to the third power source through the eighth resistor.

12. The control circuit of claim 11, wherein the switch unit further comprises ninth to tenth resistors and second to fifth capacitors, the first terminal of the first electronic switch receives the enable signal through the ninth resistor, and is coupled to the second power through the tenth resistor; the first terminal of the first electronic switch is coupled to the second power through the second capacitor, and is connected to ground through the third capacitor, the third terminal of the first electronic switch is connected to ground through the fourth capacitor, and is coupled to the first terminal of the first electronic switch through the fifth capacitor.
